(19) United States
(12) Patent Application Publication
(10) Pub. No.: US 2005/0091494 A1
(43) Pub. Date: Apr. 28, 2005

(54) Method and system for providing an external trusted agent for one or more computer systems

(76) Inventor: Chris D. Hyser, Victor, NY (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/693,182

(22) Filed: Oct. 23, 2003

(51) Int. Cl. H04L 9/00

(52) U.S. Cl. 713/171

(57) ABSTRACT

An external personal computer or other computing device is employed as an external security-state monitor to monitor the security state of one or more computer systems. The security-state monitor creates pairs of write-once CDs containing an identical sequence of encryption keys. One CD of a pair remains with the security-state monitor, and the other CD of the pair is provided to the system administrator of a computer system. Keys are employed by the security-state monitor and computer system one time only, and the current key employed can be specified by an index into the sequence of keys stored on the duplicate CDs. When the computer system carries out an initial boot into a secure state, the computer system informs the security-state monitor using the current key from the computer system's CD. The security-state monitor accordingly determines that the computer system is currently secure. Prior to loading the executing the first untrusted software, the secure software executing on the computer system sends a message to the security-state monitor indicating that the computer system is transitioning to an insecure state.

### TECHNICAL FIELD

The present invention relates to computer systems and computer-system security and, in particular, to a method and system for external monitoring of the security status of a combined software and hardware computer system.

### BACKGROUND OF THE INVENTION

The present invention is related to computer-system security. A large effort is currently underway in the computing industry to provide secure computer systems to facilitate electronic commerce, storage of confidential information in commercial and governmental institutions, secure communications, and for facilitating construction of highly available, tamper-proof computer systems. FIG. 1 is a block diagram of a number of important components within a single-processor computer-hardware platform. The hardware platform 101 includes a processor 103, random-access memory 105, and non-volatile data storage, such as a hard disk drive 107. The processor stores and retrieves data from memory 105 via a high-speed system bus 109. The high-speed system bus is interconnected to one or more lower-speed peripheral busses 111 via a system controller 113. A non-volatile data-storage controller 115 is connected to the peripheral bus 111 as well as to an input/output (“I/O”) bus 117 which is connected to the non-volatile data-storage device 107. Additional I/O controllers, such as I/O controller 119, may be connected to the one or more peripheral busses 111.

During operation, computer programs migrate from the mass-storage device or devices 107 to system memory 105, from where they are executed by the processor 103. Computer programs may also be received by an I/O controller from external devices and moved to system memory 105, from where they are executed by the processor 103. Initially, following power on of the computer system, the processor 103 may begin to execute instructions for a boot program stored in a small, non-volatile memory, such as a flash memory or other read-only memory constituting one or more integrated circuits. The manufacturer of a computer system may use various security techniques, such as digital signatures or other cryptography techniques, to ensure that only trusted, verified boot programs are executed by the processor. At a certain point during the boot process, the small boot program stored within a read-only memory device must begin to verify and then execute larger programs stored on one or more mass-storage devices, such as mass-storage device 107. Again, various security techniques, including cryptography techniques, can be used to continue a chain of trust by which each next-to-be-executed program is first verified by programs already loaded and executed. By this means, the computer system can be brought to life, in stages, following power-on or reset, in a secure fashion.

FIG. 2 is a flow-control diagram that illustrates a fundamental problem in secure computing. Following power on or reset, as described above, the computer system reads a trusted boot program from a read-only memory device and executes that trusted boot program in the initial stages of the boot process in step 202. Next, in step 204, the initially loaded boot program begins to control the hardware system to locate and move other trusted programs from one or more mass-storage devices into system memory for execution. As discussed above, this process may be continued to slowly build up a constellation of core executable programs necessary for operation of the computer system.

Trusted programs need to be, in general, computationally verified, digitally signed, and otherwise authorized for execution within a secure computer system. Unfortunately, it is neither practical nor computationally feasible to verify large computer programs, such as operating systems. Verification of operating systems is not practical, because, in general, operating systems are less frequently supplied as proprietary components of integrated computer systems by hardware manufacturers, but are instead created, manufactured and distributed by third-party operating-system vendors. More problematic is that modern operating systems are generally written to be able to incorporate additional, third-party device drivers and other software created, manufactured and distributed by additional third-party software vendors. Accessory programs, such as third-party device drivers, are generally created to be run on multiple different types of hardware platforms. It is practically infeasible for hardware vendors and operating-system vendors to require device-driver vendors to adhere to particularized and proprietary security standards.

At some point during system initialization, the secure software components of the computer system must necessarily load and execute untrusted, or, in other words, non-verified, and often non-verifiable software programs, as shown in step 206. Later, as shown in step 208, either in latter stages of the boot process or following system initialization, a program may be run that needs to determine whether or not the computer system is currently secure. In certain sophisticated systems, rather than differentiating between an absolute secure state, and an insecure state, a program may need to determine the current level of security within the computer system. For example, a system that has booted a third-party operating system may not be absolutely secure, but may be more secure than a system that has run one or more third-party application programs, or that has exchanged data with external devices via a communications medium. Should the program, in step 208, be able to ascertain the security state of the computer system, the program may undertake some action, such as storing encryption keys, in reliance on that security state. Next, additional software programs may run, as shown in step 210. Somewhat later, the same program that ran in step 208, or another, similar program, may run, in step 212, and may need to again ascertain the security state of the computer system. For example, the computer program running in step 212 may need to determine whether the computer system is currently sufficiently secure to allow the program to retrieve stored encryption keys, without fear that, by doing so, the program may expose the encryption keys to eavesdropping software agents or other malicious, untrusted processes running within the computer system. In general, the security state may only decrease in security following initialization. In other words, once the computer system reaches a state less secure than the security state of a freshly initialized system, the system cannot return to a more secure state, except by re-initialization following a reset or power on.

Thus, a central problem in secure computing, as illustrated in FIG. 2, is the problem of reliably ascertaining the security state of a computer system at various points in time. The problem is not trivial. In general, once any non-trusted software is executed, it is essentially impossible for subsequent processes to determine the security state of a computer system without relying on some independent, trusted processing entity that can monitor the security state of the computer system. FIGS. 3 and 4 illustrate one technique for monitoring the security state of the computer system currently promulgated by the trusted computing organization. As shown in FIG. 3, a trusted processing component, called the trusted platform module (“TPM”) 302, is added to the computer system. The TPM is an independent security-state monitor that provides, among other things, a simple interface to allow software processes to securely encrypt and decrypt data without risk of exposing encryption keys to malicious processes.

FIG. 4 illustrates the basic interface provided by a TPM. As shown in FIG. 4, the TPM 302 includes a processor 402, internal memory that stores security-state information representing the security state of the computer system 404, and internal memory 406 that stores private encryption keys used by the TPM to support the interface provided by the TPM to external processes. That interface includes three basic operations, illustrated in FIG. 4. First, an external process may transmit a current-state request 408 to the TPM and receive a response that includes an encapsulation of the current security state of the computer system 410. An external process may transmit a seal request 412, containing data that the external process wishes to protect 414, to the TPM which encrypts the data and returns to the external process a response 416 that includes the encrypted data 418. An external process may transmit an unseal request 420, containing encrypted data 424 previously encrypted by the TPM, to the TPM and receive a response 426 that includes the corresponding decrypted, or plain-text data 428. Thus, the TPM serves as a trusted data security device and security-state monitoring device. The TPM constantly monitors the state of the computer system by collecting various metrics from components of the computer system and determining a current state of the computer system by processing received metrics. Various types of metrics may be employed, including the contents of system memory, various hardware registers, and other components of the current, dynamic state of the computer system.

While the TPM device may provide a reliable source of security-state information to processes within, and external to, a particular computer system, computer systems must be engineered to accommodate a TPM device, and manufactured to include a TPM device, in order for internal and external processes to access the security state of the computer system through a TPM interface. Unfortunately, many existing hardware platforms do not include TPM devices. Moreover, TPM devices, and the engineering required to accommodate TPM devices, may be impractically expensive for some time. For these reasons, developers and manufacturers of secure computer systems have recognized the need for a technique or subsystem that can provide security-state information to executing processes similar to the security-state information provided by a TPM device, but without the cost and compatibility issues currently inherent in relying on the TPM interface.

### SUMMARY OF THE INVENTION

In one embodiment of the present invention, an external personal computer (“PC”) or other common, inexpensive computing device is employed as an external security-state monitor (“SMC”) to monitor the security state of one or more computer systems. The SMC creates pairs of write-once CDs, or other, similar data storage media, each pair of CDs containing an identical sequence of encryption keys. One CD of a pair remains with the SMC, and the other CD of the pair is provided to the system administrator of a computer system. Keys are employed by the SMC and computer system one time only, and the current key employed can be specified by an index into the sequence of keys stored on the duplicate CDs. When the computer system carries out an initial boot into a secure state, the computer system informs the SMC using the current key from the computer system's CD. The SMC accordingly determines that the computer system is currently secure. Prior to loading and executing the first untrusted software, the secure software executing on the computer system sends a message to the SMC indicating that the computer system is transitioning to an insecure state. The SMC records the fact that the computer system is now insecure, and thereafter considers the computer system secure until it is again reset or powered up.

### BRIEF DESCRIPTION OF THE DRAWINGS

FIG. 1 is a block diagram of a number of important components within a single-processor computer-hardware platform.

FIG. 2 is a flow-control diagram that illustrates a fundamental problem in secure computing.

FIGS. 3 and 4 illustrate one technique for monitoring the security state of the computer system currently promulgated by the trusted computing organization.

FIG. 5 illustrates the hardware components involved in SMC security-state monitoring in a described embodiment of the present invention.

FIG. 6 illustrates the contents of a CD pair that is concurrently used by the SMC in a computer system monitored by the SMC, and internal information stored by the computer system and the SMC to facilitate the data exchange that allows that SMC to monitor the security state of the computer system.

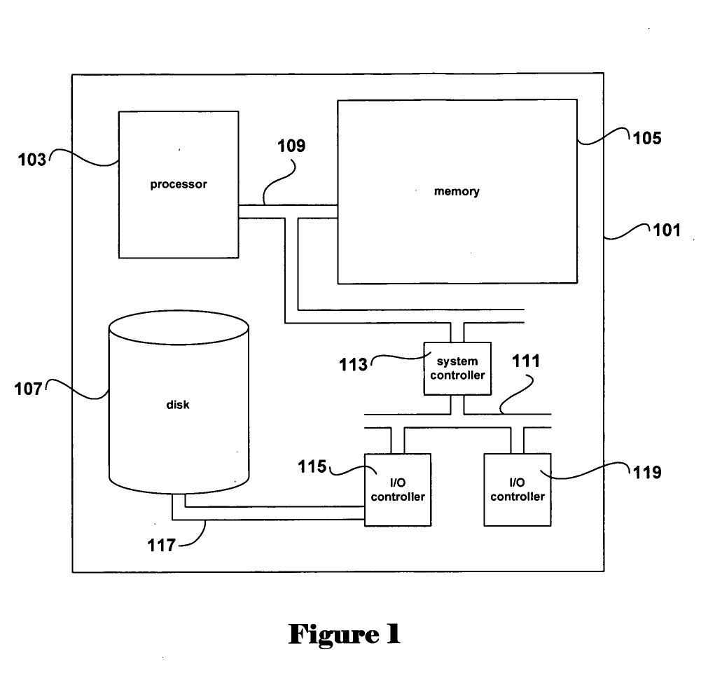

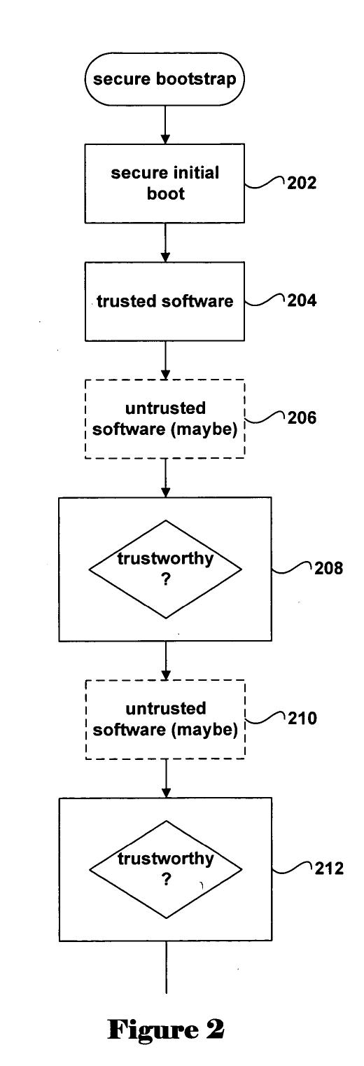

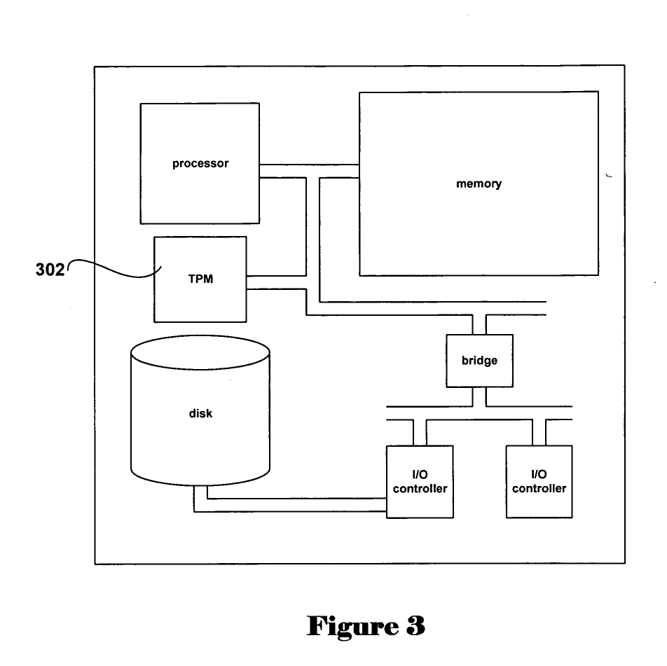

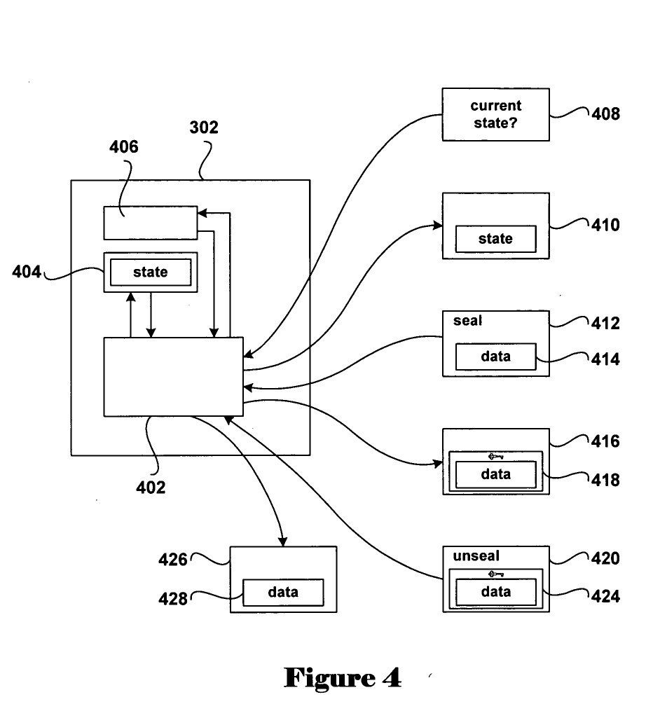

### DETAILED DESCRIPTION OF THE INVENTION

In one embodiment of the present invention, an external personal computer (“PC”) is used as an external security-state monitoring device for one or more computer systems. Although an SMC may be devised to provide an interface similar to that provided by a TPM device, discussed above, in the described embodiment of the present invention, the SMC reports only whether or not the one or more computer systems are secure. The SMC considers a computer system secure if no untrusted programs have yet been run, and considers a computer system insecure when the secure processes of the computer system report to the SMC that they are about to execute an untrusted program. The SMC considers the computer system to be thereafter insecure, until the computer system is subsequently powered on or reset. The SMC allows processes internal and external to the computer system to ascertain whether or not the computer system is currently secure. For example, programs run during a boot process may inquire of the SMC the current security state of the computer system in order to decide whether or not to temporarily expose encryption keys or other confidential information.

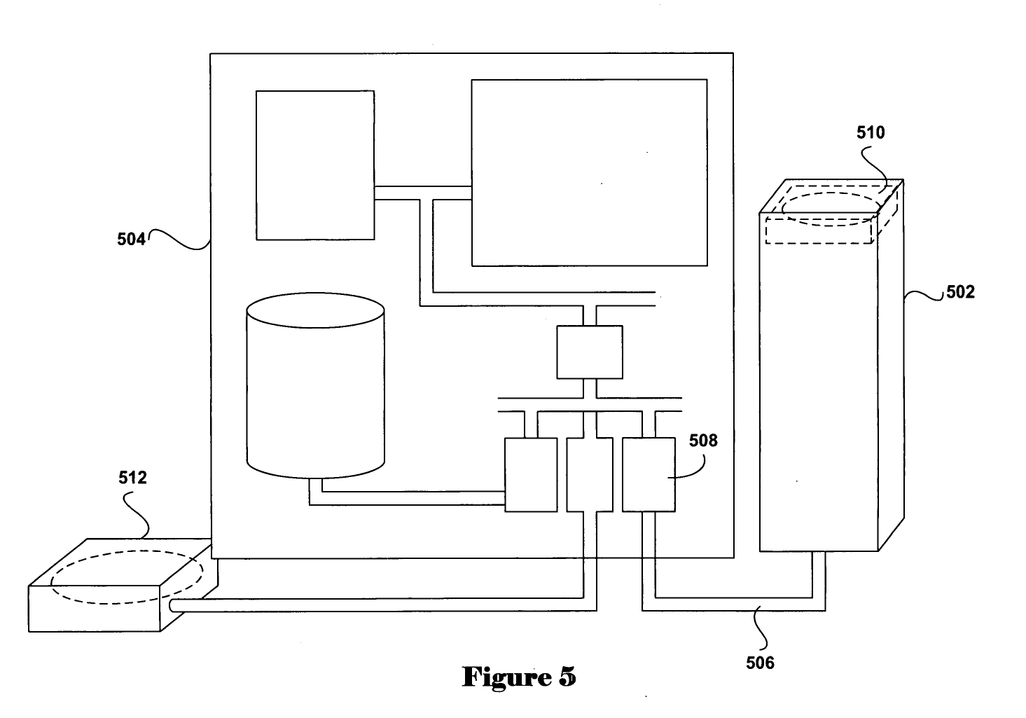

FIG. 5 illustrates the hardware components involved in SMC security-state monitoring in the described embodiment of the present invention. As shown in FIG. 5, the SMC 502, implemented using an external PC or other computing system, is connected by a communications medium 506 and a communications-medium controller 508 with a computer system 504, the security state of which it monitors. The SMC includes at least one CD-read/write device 510 for producing pairs of CDs containing encryption-key sequences, and for reading the security keys needed to communicate with a computer system whose security state it is currently monitoring. A computer system 504 monitored by the SMC also includes a CD-ROM device 512, or other device, capable of reading encryption keys from an encryption-key containing CD.

Basic cryptographic methods can be described using the following definitions:

$${A}_{m} = alphabet for messages = \{ {a}_{{m}_{1}} , {a}_{{m}_{2}} , {a}_{{m}_{3}} , … {a}_{{m}_{n}} \}$$

$${A}_{c} = alphabet for cipher \text{-} text = \{ {a}_{{c}_{1}} , {a}_{{c}_{2}} , {a}_{{c}_{3}} , … {a}_{{c}_{n}} \}$$

$$M = message \text{-} space = strings of {a}_{m}$$

$$C = cipher \text{-} text space = strings of {a}_{c}$$

$$K = key space = \{ {e}_{1} , {e}_{2} … {e}_{n} \} where {E}_{{e}_{i}} ( m ) -> c \\ = \{ {d}_{1} , {d}_{2} … {d}_{n} \} where {D}_{{d}_{i}} ( d ) -> m$$

Plain text messages are instances of messages contained within the message space M and cipher text messages are instances of the cipher text messages contained within cipher test space C. A plain text message comprises a string of one or more characters selected from a message alphabet Aₘ, while a cipher-text message comprises a string of one or more characters selected from the cipher-text alphabet A_{c}. Each encryption function E employs a key e and each decryption function D employ a key d, where the keys e and d are selected from a key space K.

A key pair is defined as follows:
key pair=(e,d)
   where eεK, dεK, D_{d}(Eₑ(m))=Eₑ(m), and mεM

One key of the key pair, e, is used during encryption to encrypt a message to cipher text via an encryption function E, and the other key of the key pair, d, can be used to regenerate the plain text message from the cipher-text message via a decryption function D. In symmetric key encryption, e and d are identical. In asymmetric, public-key cryptographic methods, key pairs (e,d) have the property that, for all key pairs (e,d), no function f(e)=d can be easily determined. Thus, the encryption key e of a public-key pair (e,d) can be freely distributed, because the corresponding decryption key d of the public-key pair cannot be determined from the encryption key e.

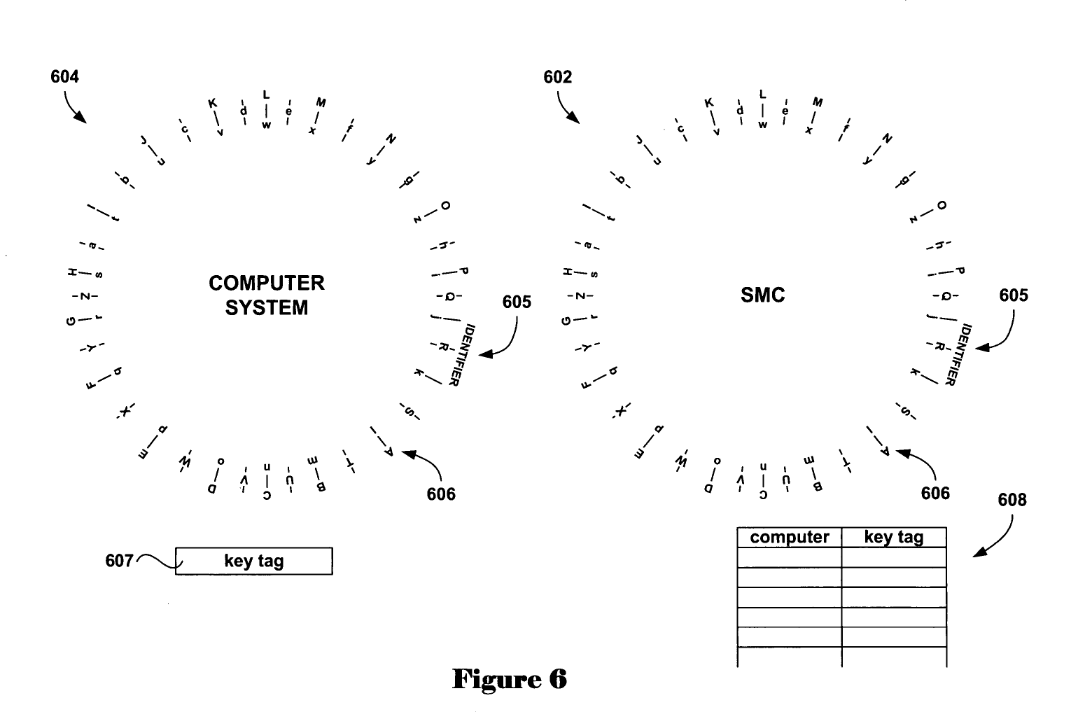

FIG. 6 illustrates the contents of a CD pair that is concurrently used by the SMC in a computer system monitored by the SMC, and internal information stored by the computer system and the SMC to facilitate the data exchange that allows that SMC to monitor the security state of the computer system. As shown in FIG. 6, the SMC prepares two identical CDs 602 and 604, each containing a sequence of encryption keys, in the case that symmetric encryption is employed, as well as a numerical identifier 605 that identifies the CD pair. In the case that asymmetric encryption is employed, the CDs contain sequences of complementary private and public encryption keys. In FIG. 6, each symmetric key or asymmetric key pair is represented by a letter, such as the letter “A” representing the first key or key pair 606 of the sequence stored on the CDs. In either case, the encryption key or encryption-key pair stored at a particular location within the sequence on a disc can be used by the computer system and the SMC to encrypt messages that are exchanged between the computer system and SMC that allow the SMC to monitor the security state of the computer system. In FIG. 6, a first CD 602 is maintained in physical collocation with the SMC, and a second computer disc 604 is provided to the system administrator of the computer system. Within the computer system, the current index, or key tag, may be stored in memory 607, while in the SMC, a table of computer-system-identifiers/key-tag pairs is stored within a table 608. Each time a computer system is powered up or reset, the key tag is advanced in order to employ the next key or key pair in the sequence stored on the CD for communications with the SMC. Keys or key pairs are not reused.

In the described embodiment of the present invention, the system administrator of the computer system must physically obtain one CD of a CD pair from the operator of the SMC, and must manually load the CD into a CD drive of the computer system in order to allow the SMC to monitor the security state of the computer system. In alternative embodiments, sequences of encryption keys or encryption key pairs may be encoded within other types of media, and may possibly be automatically generated and transported from the SMC to computer systems using secure protocols while the computer systems is in an initial, secure state.

The message protocol employed by the computer system and SMC in order to carry out SMC security-state monitoring is described, below, in a C++-like pseudocode implementation. Note that the C++-like pseudocode is not intended to represent a full implementation of all features of the computer-system/SMC security-state-monitoring operation, but is instead intended to provide illustration and sufficient information to allow those skilled in the art to easily produce a system employing the techniques of the present invention.

First, a number of enumerations, type definitions, and accessory classes are declared:

```
enum MsgType {INIT_AUTHEN, SMC_ACK, SMC_AUTHEN_ACK,
        SMC_AUTHEN_FAIL, SMC_FAIL, GOING_INSECURE,
        STATUS_QUERY, STATUS_QUERY_RESPONSE,
        STATUS_INQUIRY, STATUS_INQUIRY_RESPONSE};
enum SecurityError {NO_KEYS, ID_MISSMATCH,
ADMIN_FAILURE, SECURED,
            NOT_SECURED, GONE_INSECURE,
            LOCAL_INSECURE, ALREADY_INSECURE};
enum State {SECURE, INSECURE};
typedef unsigned int KeyTag;
typedef _int64 ID;
typedef _int64 Nonce;
typedef struct key {
_int64 w1;
_int64 w2;
_int64 w3;
_int64 w4;
} Key;
class node
{
    public:
        operator== (node nother);
};
class timer
{
    public:
        void set(int instance, int time);
        bool expired(int instance);
};
const int TIMER1 = 1;
const int TIMER2 = 2;
class metrics {};
class nonceGenerator
{
    public:
        operator== (node nother);
        Nonce getNonce( );
};
```

The enumeration “MsgType” includes the types of all messages exchanged between an SMC and a computer system whose security state the SMC monitors. These message types include the message types of initial authentication messages, SMC acknowledgement messages, SMC authentication acknowledgement messages, SMC authentication failure messages, SMC failure messages, going-insecure messages, status query messages, status-query response messages, status inquiry messages, and status-inquiry response messages. All of these types of messages are explained, below, as part of the description of pseudocode implementing the message protocol. The enumeration “SecurityError” provides return values for several routines that run on a computer system whose security state is monitored by an SMC. The enumeration “State” contains values corresponding to a secure state and an insecure state. The type definition “KeyTag” is a type for the stored index into an encryption-key sequence contained on one CD of a CD pair created by the SMC. The type “ID” corresponds to an identifier contained as the first data value on each CD of a CD pair prepared by the SMC that identifies the CD pair. The type “Nonce” is a value inserted into certain messages to prevent replay attacks and other such attempts to defeat the security-state monitoring protocol carried out by the computer system and SMC. The type “Key” represents an encryption key. In the described embodiment, a 128-bit symmetric key is employed for communications, but, as discussed above, alternate embodiments may employ asymmetric encryption-key pairs or other encryption devices. The class “node” represents a communication address of a computing entity, such as computer system or an SMC, and is used to direct messages within a communications medium. The class “timer” provides a system timing device that can be set, via the member function “set,” for a specified period of time, and that can be then queried, via the member function “expired,” to determine whether or not the specified period of time has elapsed. The argument “instance” supplied to the member function “set” is used to specify a particular timer, and the constants “TIMER1” and “TIMER2” represent two timer instances employed in the pseudocode, described below. The class “metrics” represents metrics, similar to the TPM metrics, described above, that are transmitted by a computer system to the SMC to allow the SMC to verify the security state of the computer system. In the described embodiment, only two security states—SECURE and INSECURE—are used and monitored, but, in alternate embodiments, additional levels of security may be monitored by the SMC via the metrics transmitted by computer systems to the SMC. Finally, the class “nonceGenerator” generates nonce values that are inserted into certain messages exchanged between the computer system and SMC.

The class “keyStore,” provided below, is employed by a computer system to store, in memory, the key tag index for the current key, to fetch the next key from a specified CD and update the current key tag value, and to obtain other information related to keys. The class “masterKeyStore,” also provided below, is used by the SMC in a similar fashion:

| | |
|---|---|
| 1 | class keyStore |
| 2 | { |
| 3 | public: |
| 4 | KeyTag getKeyTag( ); |
| 5 | void setKeyTag(KeyTag kt); |
| 6 | Key *getKey(int vol); |
| 7 | Key *getKey( ); |
| 8 | Key *getNextKey(int vol); |
| 9 | Key *getNextKey( ); |
| 10 | bool expectedID(ID i); |
| 11 | ID getID(int vol); |
| 12 | void clear( ); |
| 13 | }; |
| 1 | class masterKeyStore |
| 2 | { |
| 3 | public: |
| 4 | int getNewVol( ); |
| 5 | Key* getFirstKey(int vol, KeyTag & kt); |
| 6 | Key* getNextKey(int vol, KeyTag & kt); |
| 7 | Key *getCurrentKey(int vol, KeyTag & kt); |
| 8 | ID getID(int vol); |
| 9 | }; |

The keyStore member functions include: (1) “getKeyTag,” declared above on line 4, which returns the current key tag; (2) “setKeyTag,” declared above on line 5, which establishes a current key tag subsequently used by an instance of the class “keyStore” to access the current key; (3) “getKey,” declared above on line 6, which obtains the next key from a specified CD volume, where the argument “vol” indicates which CD drive, or other I/O device, to read from; (4) “getKey,” declared above on line 7, which returns the current key corresponding to the current key tag value; (5) two versions of “getNextKey,” declared above on lines 8-9, analogous to the two versions of “getKey,” that return the next key from a CD; (6) “expectedID,” declared above on line 10, which returns a true or false value corresponding to whether or not the supplied ID “i” is the same as the ID contained within the currently employed CD; (7) “getID,” declared above on line 11, which returns the identifier stored within a CD; and (8) “clear,” declared above on line 12, which clears any stored key values from memory. Member functions of the class “masterKeyStore” include: (1) “getNewVol,” declared above on line 4, which solicits insertion of a new CD into a drive accessible to the SMC; (2) “getFirstKey,” declared above on line 5, which obtains the first encryption key stored on a specified volume, in addition setting the corresponding key tag value via reference argument “kt;” (3) “getNextKey,” declared above on line 6, which obtains the next key for the specified volume; (4) “getCurrentKey,” declared above on line 7, which returns the current key and current key tag value for the specified volume; and (5) “getID,” declared above on line 8, which returns the identifier of the specified volume. Note that, in the described embodiment, the volume arguments “vol” are passed to these functions via input by system administrators of the SMC and computer systems, respectively. In alternate embodiments, automated techniques may be employed to provide the volume specifications, in certain cases.

The class “metricsCollector,” declared below, includes the member function “getCurrentMetrics” that is called by the computer system to collect metrics used by the SMC to determine the security state of the computer system:

| | |
|---|---|
| 1 | class metricsCollector |
| 2 | { |
| 3 | public: |
| 4 | void getCurrentMetrics(metrics & m); |
| 5 | }; |

The class “message” is the base class for all messages exchanged between the computer system and the SMC:

| | |
|---|---|
| 1 | class message |
| 2 | { |
| 3 | private: |
| 4 | node to; |
| 5 | node from; |
| 6 | public: |
| 7 | virtual MsgType whatType( ); |
| 8 | node getTo( ); |
| 9 | void setTo(node & n); |
| 10 | node getFrom( ); |
| 11 | void setFrom(node & n); |
| 12 | message( ); |
| 13 | ˜message( ); |
| 14 | }; |

The class “message” includes private data members “to” and “from,” declared above on lines 4-5, that indicate the intended recipient and the sender of the message, respectively. The class “message” includes the member function “whatType,” declared above on line 7, that returns the type of message, and member functions to store and retrieve a sender and receiver of a message, along with a constructor and destructor, declared above on lines 8-13.

Next, declarations for all the different types of messages employed in communications between the computer system and the SMC are provided:

| | |
|---|---|
| 1 | class initAuthenMsg : public message |
| 2 | { |
| 3 | private: |
| 4 | Nonce nonce; |
| 5 | metrics met; |
| 6 | public: |
| 7 | Nonce getNonce( ); |
| 8 | metrics* getMetrics( ); |
| 9 | MsgType whatType( ) {return INIT_AUTHEN;}; |
| 10 | initAuthenMsg(node & to, metrics & m, Nonce nonce); |
| 11 | }; |
| 1 | class smcAckMsg : public message |
| 2 | { |
| 3 | private: |
| 4 | Nonce nonce; |
| 5 | public: |
| 6 | Nonce getNonce( ); |
| 7 | MsgType whatType( ) {return SMC_ACK;}; |
| 8 | smcAckMsg(node & to, Nonce nonce); |
| 9 | }; |
| 1 | class smcFailMsg : public message |
| 2 | { |
| 3 | public: |
| 4 | MsgType whatType( ) {return SMC_FAIL;}; |
| 5 | smcFailMsg(node & to); |
| 6 | }; |
| 1 | class smcAuthenAckMsg : public message |
| 2 | { |
| 3 | private: |
| 4 | Nonce nonce; |
| 5 | public: |
| 6 | Nonce getNonce( ); |
| 7 | MsgType whatType( ) {return SMC_AUTHEN_ACK;}; |
| 8 | smcAuthenAckMsg(node & to, Nonce nonce); |
| 9 | }; |
| 1 | class smcAuthenFailMsg : public message |
| 2 | { |
| 3 | private: |
| 4 | Nonce nonce; |
| 5 | KeyTag ktag; |
| 6 | ID id; |
| 7 | public: |
| 8 | Nonce getNonce( ); |
| 9 | KeyTag getKeyTag( ); |
| 10 | ID getID( ); |
| 11 | MsgType whatType( ) {return SMC_AUTHEN_FAIL;}; |
| 12 | smcAuthenFailMsg(node & to, KeyTag kt, ID i, Nonce nonce); |
| 13 | }; |
| 1 | class goingInsecureMsg : public message |
| 2 | { |
| 3 | private: |
| 4 | Nonce nonce; |
| 5 | public: |
| 6 | Nonce getNonce( ); |
| 7 | MsgType whatType( ) {return GOING_INSECURE;}; |
| 8 | goingInsecureMsg(node & to, Nonce nonce); |
| 9 | }; |
| 1 | class statusQueryMsg : public message |
| 2 | { |
| 3 | private: |
| 4 | Nonce nonce; |
| 5 | public: |
| 6 | Nonce getNonce( ); |
| 7 | MsgType whatType( ) {return STATUS_QUERY;}; |
| 8 | statusQueryMsg(node & to, Nonce nonce); |
| 9 | }; |
| 1 | class statusQueryResponseMsg : public message |
| 2 | { |
| 3 | private: |
| 4 | metrics met; |
| 5 | public: |
| 6 | Nonce getNonce( ); |
| 7 | metrics* getMetrics( ); |
| 8 | MsgType whatType( ) {return |
| | STATUS_QUERY_RESPONSE;}; |
| 9 | statusQueryResponseMsg(node & to, Nonce nonce, |
| | metrics & m); |
| 10 | }; |
| 1 | class statusInquiryMsg : public message |
| 2 | { |
| 3 | private: |
| 4 | node n; |
| 5 | public: |
| 6 | node getNode( ); |
| 7 | MsgType whatType( ) {return STATUS_INQUIRY;}; |
| 8 | statusInquiryMsg(node & to, node & n); |
| 9 | }; |
| 1 | class statusInquiryResponseMsg : public message |
| 2 | { |
| 3 | private: |
| 4 | node n; |
| 5 | public: |
| 6 | MsgType whatType( ) {return |
| | STATUS_INQUIRY_RESPONSE;}; |
| 7 | statusInquiryResponseMsg(node & to, State s, node & n); |
| 8 | }; |

The class “initAuthenMsg” is the first message sent by a computer system to the SMC following initial boot. It contains data members “nonce” and “met” that contain a nonce generated by the computer system for the message and a collection of metrics sent to the SMC in the message to enable the SMC to ascertain the security state of the computer system, respectively. The class “initAuthenMsg” contains member functions to retrieve the nonce and the metrics contained within the message, a class-specific member function “whatType,” and a constructor that allows an instance of the class “initAuthenMsg” to be constructed. The remaining class declarations for messages have the same pattern, and will not be further described, in the interest of brevity. Note that the use of each of these message types is discussed, below, with respect to pseudocode that generates and receives the messages.

The class “secureCommunication,” provided below, represents an interface to a communications medium that allows the computer system to send messages to the SMC and that allows the SMC to send messages to the computer system:

| | |
|---|---|
| 1 | class secureCommunication |
| 2 | { |
| 3 | public: |
| 4 | bool send(message *m, Key* k); |
| 5 | bool sendFor(message *m, Key* k, int retries); |
| 6 | bool sendUntil(message *m, Key* k, int waitFor); |
| 7 | bool sendFor(message *m, Key* k, int retries, int waitFor); |
| 8 | bool send(message *m); |
| 9 | bool sendFor(message *m, int retries); |
| 10 | bool sendUntil(message *m, int waitFor); |
| 11 | bool sendFor(message *m, int retries, int waitFor); |
| 12 | bool receive(message *m, Key* k, int sec); |
| 13 | bool receive(message *m, node n, Key* k, int sec); |
| 14 | bool receive(message *m, int sec); |
| 15 | bool receive(message *m, node n, int sec); |
| 16 | bool decrypt(message *m, Key* k); |
| 17 | communication ( ); |
| 18 | }; |

The class SecureCommunication includes a number of different member functions for sending and receiving messages, declared above on lines 4-15. Certain send functions include arguments that specify encryption keys so that messages are encrypted before sending. Other send functions do not include specifications of encryption keys, and therefore send messages unencrypted. Similarly, those receive functions that include arguments that specify encryption keys automatically decrypt messages while receive functions that do not include specifications of keys receive only the message type, and the accessory function “decrypt,” declared above on line 16, must then be used to decrypt the body of the message. The first send function member, declared above on line 4, simply sends a message once. The second send function member, “sendFor,” declared above on line 5, repeatedly sends a message until an acknowledgement is received, with the number of repetitions specified by the argument “retries.” The third send function member, “sendUntil,” declared above on line 6, sends the message and waits for a specified time period for an acknowledgement to be received. The fourth send function member, “sendFor,” declared above on line 7, repeatedly sends a message and waits for a specified time interval to obtain an acknowledgement. A similar set of send function members are declared on lines 8-11 that do not receive encryption keys as arguments. The receive function members include receive function members that receive only messages from a specified node, declared above on lines 13 and 15, and receive function members that receive messages from any node, declared above on lines 12 and 14. The receive function members declared above, on lines 12-13, receive encryption keys for automatic decryption of messages, while the receive function members declared above on lines 14-15 do not automatically decrypt received messages. In all cases, send and receive function members return a Boolean value indicating whether or not a message was successfully sent or received.

Next, a number of constants that specify the number of times sending of a message should be retried and various wait periods for receiving messages are provide, below:

1 const int MAX_SECURE_TRIES = 50;
2 const int MAX_INSECURE_TRIES = 3;
3 const int MAX_STATUS_TRIES = 3;
4 const int MAX_SMC_TRIES = 3;
5 const int MAX_WAIT = 500;
6 const int MSG_WAIT1 = 150;
7 const int MSG_WAIT2 = 50;
8 const int MSG_WAIT_SMC = 10;

Next, a declaration for the class “computer” is provided, below:

| | |
|---|---|
| 1 | class computer |
| 2 | { |
| 3 | private: |
| 4 | secureCommunication com; |
| 5 | node smc; |
| 6 | nonceGenerator nonceGen; |
| 7 | keyStore Kstore; |
| 8 | metricsCollector metCol; |
| 9 | timer tm; |
| 10 | State state; |
| 11 | void wait(int time); |
| 12 | public: |
| 13 | SecurityError establishSecureState(int vol); |
| 14 | SecurityError goInsecure( ); |
| 15 | void listenAndRespond( ); |
| 16 | computer( ); |
| 17 | }; |

The class “computer” models those portions of a computer system involved in the message protocol that allows an SMC to monitor the security state of that computer system. Of course, the current pseudocode implementation is not intended to in any way model or reflect the complexity of an actual computer system. The class “computer” includes the following data members: (1) “com,” declared above on line 4, which is an instance of the class “secureCommunication;” (2) “smc,” declared above on line 5, an instance of the class “node” that represents the communications address of the SMC; (3) “nonceGen,” declared above on line 6, an instance of the class “nonceGenerator;” (4) “Kstore,” declared above on line 7, an instance of the class “keyStore,” that stores the current key tag and interfaces to a combination of memory and a CD drive for obtaining keys from a key sequence stored on the CD; (5) “metCol,” declared above on line 8, an instance of the class “metricsCollector,” that collects metrics to transmit to the SMC to allow the SMC to determine the security state of the computer system; (6) “tm,” declared above on line 9, an instance of the class “timer;” and (7) “state,” declared above on line 10, a variable containing the current state of the computer system. The class “computer” includes the following function member declarations: (1) “wait,” declared above on line 11, a private function member that suspends execution of the calling process for a specified period of time when called by a process; (2) “establishSecureState,” declared above on line 13, that carries out the initial part of the message exchange between the computer system and the SMC following booting of the computer system; (3) “goInsecure,” declared above on line 14, that carries out that portion of the message exchange between the computer system and the SMC to inform the SMC that the computer system is transitioning to an insecure state; and (4) “listenAndRespond,” declared above on line 15, that runs asynchronously within the computer system to field status query messages sent from the SMC.

Next are provided a constant declaration and two struct typedef declarations used by the class “SMC,” to be discussed below:

| const int MAX_NODES = 100; | | |
|---|---|---|
| struct inquirer; | | |
| 1 | typedef struct inquirer | |
| 2 | { | |
| 3 | inquirer* next; | |
| 4 | node n; | |
| 5 | } Inquirer; | |
| 1 | typedef struct nodeState | |
| 2 | { | |
| 3 | node | n; |
| 4 | State | s; |
| 5 | KeyTag | curKT; |
| 6 | ID | curID; |
| 7 | int | vol; |

| | |
|---|---|
| 8 | Inquirer* inquiries; |
| 9 | Nonce no; |
| 10 | } NodeState; |

The constant “MAX_NODES” is the number of computer systems that the SMC can concurrently monitor for security states. The type declaration “inquirer,” declared above, stores the communications address, in the field “n,” declared on line 4, for internal and external programs that request information about the security state of a computer system. The type definition “NodeState” declares a type of structure used to store information about those computer systems currently being monitored by the SMC. The information stored by the SMC for each security system that it is monitoring include the communications address, in field “n,” declared above on line 3, the current security state, stored in field “s,” the current key tag stored in field “curKT,” the identifier of the CD currently being used both by the SMC and the computer system for storing encryption key sequences, stored in the field “curID,” the volume or drive containing the CD for the computer system, stored in the field “vol,” a linked list of inquirer structures that include all nodes without standing status queries directed to the computer system, stored in the field “inquiries,” and a nonce sent in the last message by the SMC to the computer system, stored in the field “no.”

Next, the class “returnMessages” is provided:

| | |
|---|---|
| 1 | class returnMessages |
| 2 | { |
| 3 | public: |
| 4 | void insert(message* m, NodeState* ns); |
| 5 | bool getNext(message & m, NodeState* ns); |
| 6 | void clear( ); |
| 7 | }; |

The class “returnMessages” is used to store a number of messages by the SMC for sending to computer systems and processes inquiring about the status of computer systems during a single iteration of a main event-handling loop that runs within the SMC. The class “returnMessages” includes function members to insert and retrieve messages from an instance of the class “returnMessages.”

Finally, a declaration for the class “SMC” is provided, below. Note, as with the class “computer,” declared above, the class “SMC” is not intended in any way to represent a complete implementation of an SMC, but is instead intended to illustrate operation of the above-described message protocol based on encryption keys contained in pairs of CDs shared by the SMC and a computer system.

| | |
|---|---|
| 1 | class SMC |
| 2 | { |

| | |
|---|---|
| 3 | private: |

| | |
|---|---|
| 4 | nonceGenerator nonceGen; |
| 5 | secureCommunication com; |
| 6 | NodeState states[MAX_NODES]; |
| 7 | masterKeyStore keys; |
| 8 | NodeState* findState(node & n); |
| 9 | NodeState* insertNode(node & n, State s, KeyTag kt, |

| | |
|---|---|
| 10 | ID curID, int vol); |

| | |
|---|---|
| 11 | bool verifyMetrics(metrics* m); |
| 12 | bool getNextInquirer(Inquirer & i, NodeState* ns); |
| 13 | bool insertInquirer(node n, NodeState* ns); |

| | |
|---|---|
| 14 | public: |

| | |
|---|---|
| 15 | void listenAndRespond( ); |
| 16 | SMC( ); |

| | |
|---|---|
| 17 | }; |

An instance of the class “SMC” includes the following data members: (1) “nonceGen,” declared above on line 4, an instance of the class “nonceGenerator;” (2) “com,” declared above on line 5, an instance of the class “secureCommunication;” (3) “states,” an array of instances of the class “NodeState,” used to store information about each computer system that the SMC is currently monitoring; and (4) “keys,” an instance of the class “masterKeyStore,” which manages storage of current keys for each computer system being monitored and manages extraction of keys from CD-ROMs. The class “SMC” includes the following function members: (1) “findState,” declared above on line 8, which finds the instance of the class “NodeState” corresponding to a communications address of a computer system, supplied as argument “n;” (2) “insertNode,” declared above on lines 9 and 10, that inserts an instance of the class “NodeState” into the data member “states;” (3) “verifyMetrics,” declared above on line 11, which analyzes metrics supplied by the computer system to determine the security state of the computer system, returning the Boolean value true when the metrics indicate that the computer system is secure; (4) “getNextInquirer,” declared above on line 12, that retrieves known addresses for processors waiting to receive responses to state inquiries for a particular server computer; (5) “insertInquirer,” declared above on line 13, which inserts the address of a process into a list of processes waiting to receive a response to a status inquiry with respect to a particular computer system; and (6) “listenAndRespond,” declared above on line 15, that essentially comprises a constantly repeating event-handler loop within the SMC.

Next, a C++-like pseudocode implementation of the function member “establishSecureState” of the class “computer” is provided:

| | |
|---|---|
| 1 | SecurityError computer::establishSecureState(int vol) |
| 2 | { |

| | |
|---|---|
| 3 | Key* key; |

| | |
|---|---|
| 4 | initAuthenMsg* iaMsg; |
| 5 | Nonce n; |
| 6 | message m; |
| 7 | metrics met; |
| 8 | for (int i = 0; i < 2; i++) |
| 9 | { |

| | |
|---|---|
| 10 | key = Kstore.getNextKey(vol); |
| 11 | if (key == NULL) return NO_KEYS; |
| 12 | n = nonceGen.getNonce( ); |
| 13 | metCol.getCurrentMetrics(met); |
| 14 | iaMsg = new initAuthenMsg(smc, met, n); |
| 15 | if (com.sendFor(iaMsg, key, MAX_SECURE_TRIES, MAX_WAIT)) |
| 16 | { |

| | |
|---|---|
| 17 | delete iaMsg; |
| 18 | tm.set(TIMER1, MSG_WAIT1); |
| 19 | while (!tm.expired(TIMER1)) |
| 20 | { |

| | |
|---|---|
| 21 | if (com.receive(&m, smc, key, MSG_WAIT2)) |
| 22 | { |

| | |
|---|---|
| 23 | if (m.whatType( ) == SMC_AUTHEN_ACK && |

| | |
|---|---|
| 24 | ((initAuthenMsg*)&m)->getNonce( ) == n) |

| | |
|---|---|
| 25 | { |

| | |
|---|---|
| 26 | state = SECURE; |
| 27 | return SECURED; |

| | |
|---|---|
| 28 | } |
| 29 | else if (m.whatType( ) == SMC_AUTHEN_FAIL && |

| | |
|---|---|
| 30 | ((smcAuthenFailMsg*)&m)->getNonce( ) == n) |

| | |
|---|---|
| 31 | { |

| | |
|---|---|
| 32 | Kstore.setKeyTag(((smcAuthenFailMsg*)&m)->getKeyTag( )); |
| 33 | if (!Kstore.expectedID(((smcAuthenFailMsg*)&m)->getID( ))) |

| | |
|---|---|
| 34 | return ID_MISSMATCH; |

| | |
|---|---|
| 35 | break; |

| | |
|---|---|
| 36 | } |
| 37 | else if ((m.whatType( ) == SMC_FAIL)) return ADMIN_FAILURE; |

| | |
|---|---|
| 38 | } |

| | |
|---|---|
| 39 | } |

| | |
|---|---|
| 40 | } |

| | |
|---|---|
| 41 | } |
| 42 | state = INSECURE; |
| 43 | return NOT_SECURED; |

| | |
|---|---|
| 44 | } |

The function member “establishSecureState” receives an indication of an appropriate CD drive, or other I/O device, that contains the key sequence needed for establishing communications with the SMC in the input argument “vol.” In the described embodiment, the value of this input argument is ultimately supplied by a human system administrator, who loads the needed CD of a CD pair originally created by the SMC into an appropriate I/O device. In alternate embodiments, a more automated approach may be employed, although considerable attention needs to be paid, in those cases, to authorizing and securing automated messages for establishing key sequences. Thus, in the described embodiment, the trustworthiness of security-state reporting by the SMC depends on a system administrator correctly obtaining one CD of a CD pair and loading it into an appropriate I/O device interconnected with the computer system that is to be monitored by the SMC.

The function member “establishSecureState” includes the following local variables, declared above on lines 3-7: (1) “key,” a pointer to the current key needed for communications with the SMC; (2) “iaMsg,” a pointer to an initial authentication message, an instance of the class “initAuthenMsg;” (3) “n,” a nonce generated for inclusion in a message; (4) “m,” an instance of the base class “message;” and (5) “met,” an instance of the class “metrics.” The for-loop comprising lines 8-40 repeats an attempt to establish communications with the SMC several times. In the event that communications with the SMC are not established, then the state of the computer system is set to be insecure, on line 41, and the returned value “NOT_SECURED” is returned on line 42. Thus, if communications is not successfully established with the SMC, then the SMC will not report that the computer system is secure, and the computer system should proceed according to being in an insecure state. For example, during a secure boot sequence, the secure boot program may elect to halt if communications are not successfully established with the SMC.

In each iteration of the for-loop of lines 8-41, the function member “establishSecureState” proceeds as follows. First, on line 10, the local variable “key” is set to point to the current key needed to communicate with the SMC. The data member “Kstore” retrieves the next key in the key sequence using a stored current key tag value when the identifier of the CD matches a stored last-used identifier, if one is available, and may otherwise default to using the first key. If no key is returned, as detected on line 11, then function member “establishSecureState” returns the returned value “NO_KEYS” on line 11. This error condition may be reported back to the system administrator, who can diagnose the problem and perhaps reload the appropriate CD of a CD pair into an I/O device accessible to the computer system. Otherwise, on line 12, a nonce is generated by a call to the data member “nonceGen” and stored in local variable “n.” On line 13, the data member “metCol” is called to gather and report a set of metrics that reflect the current security state of the computer system. These metrics are similar to metrics employed by a TPM device, described above, and may include the values of various words in system memory, the values of various hardware registers, and other such information. Next, on line 14, a new initial authentication message is created, and the local variable “iaMsg” is set to refer to the newly created initial authentication message. On line 15, the newly created initial authentication message is sent through the communications interface represented by the data member “com” to the SMC. Note that the function member “sendFor” of the class “secureCommunications” is used, specifying that the send be retried a number of times over a period of MAX_WAIT seconds. If the message is successfully sent to the SMC, then, on line 18, a first timer is set and the loop comprising lines 19-39 is iterated until the timer expires or until a response to the initial authentication message is received from the SMC. In the loop, a return message from the SMC is attempted to be received via a call to the function member “receive” of data member “com,” on line 21. If the function member “receive” returns the Boolean value TRUE, then a message was received from the SMC. In that case, the type of the received message is checked, on line 23, to see whether the received message is an SMC_AUTHEN_ACK message and whether the nonce, return of the message, is equal to the nonce that was inserted into the initial authentication message on line 14. If the received message was an SMC_AUTHEN_ACK message and the nonce received in that message is equal to the nonce sent in the initial authentication message, then communications have been established with the SMC, and the SMC considers the computer system to be secure. Therefore, the data member “state” is set to the value “SECURE,” on line 26, and the returned value “SECURED” is returned on line 27. If, on the other hand, the message received from the SMC is an SMC_AUTHEN_FAIL message, as detected on line 29, and if the nonce received in that message is equal to the nonce originally included in the initial authentication message, then the current key tag expected by the SMC is extracted from the SMC authentication failure message, on line 32, and stored via a call to the function member “setKey” of the data member “Kstore.” If the identifier extracted from the SMC authentication failure message does not match the identifier expected by data member “kStore,” or, in other words, the returned identifier does not match the identifier of the CD inserted by the system administrator, then the returned value “ID_MISSMATCH” is returned on line 34. Otherwise, the break on line 35 discontinues execution of the while-loop of lines 19-39, invoking a second iteration of the enclosing for-loop of lines 8-41. On the second iteration of the for-loop, the correct key tag is used for retrieving the key used to encrypt the initial authentication message again sent to the SMC. If the message received from the SMC is neither an SMC authentication ACK message or an SMC authentication failure message, as detected on line 37, then the returned value “ADMIN_FAILURE” is returned, to indicate that some system administration error has probably transpired, so that the system administrator can undertake to correct that error.

Next, an implementation for the function member “goInsecure” of the class “computer” is provided. This function member is called at a point when the computer system is ready to first call untrusted code, for example, during a boot sequence, as described above.

| | |
|---|---|
| 1 | SecurityError computer::goInsecure( ) |
| 2 | { |

| | |
|---|---|
| 3 | Key* key; |
| 4 | goingInsecureMsg* giMsg; |
| 5 | Nonce n; |
| 6 | message m; |
| 7 | state = INSECURE; |
| 8 | key = Kstore.getKey( ); |
| 9 | if (key == NULL) return ALREADY_INSECURE; |
| 10 | n = nonceGen.getNonce( ); |
| 11 | giMsg = new goingInsecureMsg(smc, n); |
| 12 | if (com.sendFor(giMsg, key, MAX_INSECURE_TRIES, MAX_WAIT)) |
| 13 | { |

| | |
|---|---|
| 14 | delete giMsg; |
| 15 | tm.set(TIMER2, MSG_WAIT1); |
| 16 | while (!tm.expired(TIMER2)) |
| 17 | { |

| | |
|---|---|
| 18 | if (com.receive(&m, smc, key, MSG_WAIT2)) |
| 19 | { |

| | |
|---|---|
| 20 | if (m.whatType( ) == SMC_ACK && ((smcAckMsg*)&m)->getNonce( ) == n) |
| 21 | { |

| | |
|---|---|
| 22 | Kstore.clear( ); |
| 23 | return GONE_INSECURE; |

| | |
|---|---|
| 24 | } |

| | |
|---|---|
| 25 | } |

| | |
|---|---|
| 26 | } |

| | |
|---|---|
| 27 | } |
| 28 | Kstore.clear( ); |
| 29 | return LOCAL_INSECURE; |

| | |
|---|---|
| 30 | } |

Much of the details of this routine are similar to those in the above-described function member “establishSecureState,” and will not be annotated to the level of annotation in the description of that function member. In essence, a new going insecure message is created, on line 11, and is sent to the SMC on line 12. Note that, regardless of whether a response is received, the locally maintained state for the computer system is INSECURE as a result of a call to function member “goInsecure.” If the current key for communications with the SMC are not found, then the returned value “ALREADY_INSECURE” is returned. If the SMC responds to the going insecure message, as detected on line 19, then the returned value “GONE_INSECURE” is returned on line 22. If no response is received, then the returned value “LOCAL_INSECURE” is returned on line 28. Note that a byproduct of going insecure is a call to the function member “clear” of the data member “Kstore,” either on line 21 or line 27. This call clears any memory-resident representations of encryption keys, to insure that, following a call to untrusted software, the encryption key cannot be discovered by a malicious program and used in order to attempt to communicate with the SMC.

Next, a C++-like pseudocode implementation of the function member “listenAndRespond” of class “computer” is provided below:

| | |
|---|---|
| 1 | void computer::listenAndRespond( ) |
| 2 | { |

| | |
|---|---|
| 3 | Key* key; |
| 4 | statusQueryResponseMsg* sqrMsg; |
| 5 | Nonce n; |
| 6 | message m; |

| | |
|---|---|
| 7 | metrics met; |
| 8 | while (true) |
| 9 | { |

| | |
|---|---|
| 10 | if (state != SECURE) return; |
| 11 | key = Kstore.getKey( ); |
| 12 | if (key == NULL) return; |
| 13 | if (com.receive(&m, smc, key, MSG_WAIT1)) |
| 14 | { |

| | |
|---|---|
| 15 | if (m.whatType( ) == STATUS_QUERY) |
| 16 | { |

| | |
|---|---|
| 17 | n = ((statusQueryMsg*)&m)->getNonce( ); |
| 18 | metCol.getCurrentMetrics(met); |
| 19 | sqrMsg = new statusQueryResponseMsg(smc, n, |
| | met); |
| 20 | com.sendFor(sqrMsg, key, MAX_STATUS_{—} |
| | TRIES); |

| | |
|---|---|
| 21 | delete sqrMsg; |
| 22 | } |

| | |
|---|---|
| 23 | } |

| | |
|---|---|
| 24 | } |

| | |
|---|---|
| 25 | } |

This function member is executed by an asynchronous process within the computer system to continuously detect status query messages sent to the computer system by the SMC and respond to those messages. In this implementation, the process terminates as soon as the process detects that the computer system has transitioned to an insecure state. A response to a status query message is a status query response message that contains metrics by which the SMC can determine the security status of the computer system. Note that, the nonce received in the status query message on line 17 must be returned to the SMC in the newly created status query response message, on line 19.

Finally, a C++-like pseudocode implementation of the SMC function member “listenAndRespond” is provided below:

| | |
|---|---|
| 1 | void SMC::listenAndRespond( ) |
| 2 | { |

| | |
|---|---|
| 3 | message m; |
| 4 | message* ret; |
| 5 | returnMessages rM; |
| 6 | metrics* met; |
| 7 | NodeState* nS; |
| 8 | node nd; |
| 9 | Key* key; |
| 10 | KeyTag kt; |
| 11 | Inquirer inq; |
| 12 | bool OK; |
| 13 | State st; |

| | |
|---|---|
| 14 | while (true) |
| 15 | { |

| | |
|---|---|
| 16 | if (com.receive(&m, MSG_WAIT_SMC)) |
| 17 | { |

| | |
|---|---|
| 18 | nd = m.getFrom( ); |
| 19 | switch (m.whatType( )) |
| 20 | { |

| | |
|---|---|
| 21 | case INIT_AUTHEN: |

| | |
|---|---|
| 22 | nS = findState(nd); |
| 23 | if (nS != NULL) |
| 24 | { |

| | |
|---|---|
| 25 | nS->s = INSECURE; |
| 26 | key = keys.getNextKey(nS->vol, kt); |
| 27 | if (com.decrypt(&m, key)) |
| 28 | { |

| | |
|---|---|
| 29 | met = ((initAuthenMsg*)&m)->getMetrics( ); |
| 30 | if (verifyMetrics(met)) |
| 31 | { |

| | |
|---|---|
| 32 | ret = new smcAuthenAckMsg |

| | |
|---|---|
| 33 | (nd, ((initAuthenMsg*)&m)->getNonce( )); |

| | |
|---|---|
| 34 | nS->s = SECURE; |

| | |
|---|---|
| 35 | } |

| | |
|---|---|
| 36 | else ret = new smcFailMsg(nd); |

| | |
|---|---|
| 37 | } |
| 38 | else ret = new smcAuthenFailMsg |

| | |
|---|---|
| 39 | (nd, nS->curKT, nS->curID, |
| 40 | ((initAuthenMsg*)&m)->getNonce( )); |

| | |
|---|---|
| 41 | } |
| 42 | else ret = new smcFailMsg(nd); |
| 43 | rM.insert(ret, nS); |
| 44 | break; |
| 45 | |

| | |
|---|---|
| 46 | case GOING_INSECURE: |

| | |
|---|---|
| 47 | nS = findState(nd); |
| 48 | if (nS != NULL) |
| 49 | { |

| | |
|---|---|
| 50 | nS->s = INSECURE; |
| 51 | ret = new smcAckMsg(nd, ((goingInsecureMsg*)&m)->getNonce( )); |
| 52 | rM.insert(ret, nS); |

| | |
|---|---|
| 53 | } |
| 54 | break; |
| 55 | |

| | |
|---|---|
| 56 | case STATUS_QUERY_RESPONSE: |

| | |
|---|---|
| 57 | nS = findState(nd); |
| 58 | OK = false; |
| 59 | if (nS != NULL) |
| 60 | { |

| | |
|---|---|
| 61 | key = keys.getCurrentKey(nS->vol, kt); |
| 62 | if (com.decrypt(&m, key)) |
| 63 | { |

| | |
|---|---|
| 64 | if (verifyMetrics(((statusQueryResponseMsg*)&m)->getMetrics( )) && |

| | |
|---|---|
| 65 | ((statusQueryResponseMsg*)&m)->getNonce( ) == nS->no) |

| | |
|---|---|
| 66 | { |

| | |
|---|---|
| 67 | OK = true; |
| 68 | nS->s = SECURE; |

| | |
|---|---|
| 69 | } |

| | |
|---|---|
| 70 | } |
| 71 | else nS->s = INSECURE; |

| | |
|---|---|
| 72 | } |
| 73 | if (OK) st = SECURE; |
| 74 | else st = INSECURE; |
| 75 | while (getNextInquirer(inq, nS)) |
| 76 | { |

| | |
|---|---|
| 77 | ret = new statusInquiryResponseMsg(inq.n, st, nd); |
| 78 | rM.insert(ret, nS); |

| | |
|---|---|
| 79 | } |
| 80 | break; |
| 81 | |

| | |
|---|---|
| 82 | case STATUS_INQUIRY: |

| | |
|---|---|
| 83 | node nd1 = ((statusInquiryMsg*)&m)->getNode( ); |
| 84 | nS = findState(nd1); |
| 85 | if (nS == NULL) |
| 86 | { |

| | |
|---|---|
| 87 | ret = new statusInquiryResponseMsg(inq.n, INSECURE, nd); |
| 88 | rM.insert(ret, NULL); |

| | |
|---|---|
| 89 | } |
| 90 | else |
| 91 | { |

| | |
|---|---|
| 92 | if (insertInquirer(nd, nS)) |
| 93 | { |

| | |
|---|---|
| 94 | nS->no = nonceGen.getNonce( ); |
| 95 | ret = new statusQueryMsg(nS->n, nS->no); |
| 96 | rM.insert(ret, nS); |

| | |
|---|---|
| 97 | } |

| | |
|---|---|
| 98 | } |
| 99 | break; |

| | |
|---|---|
| 100 | } |
| 101 | while (rM.getNext(m, nS)) |
| 102 | { |

| | |
|---|---|
| 103 | switch (m.whatType( )) |
| 104 | { |

| | |
|---|---|
| 105 | case SMC_AUTHEN_ACK: |
| 106 | case STATUS_QUERY: |

| | |
|---|---|
| 107 | key = keys.getCurrentKey(nS->vol, kt); |
| 108 | com.sendFor(m, key, MAX_SMC_TRIES); |
| 109 | break; |
| 110 | |

| | |
|---|---|
| 111 | case SMC_AUTHEN_FAIL: |
| 112 | case SMC_ACK: |
| 113 | case SMC_FAIL: |
| 114 | case STATUS_INQUIRY_RESPONSE: |

| | |
|---|---|
| 115 | com.sendFor(m, MAX_SMC_TRIES); |
| 116 | break; |

| | |
|---|---|
| 117 | } |
| 118 | delete m; |

| | |
|---|---|
| 118 | } |

| | |
|---|---|
| 119 | } |

| | |
|---|---|
| 120 | } |

| | |
|---|---|
| 121 | } |

Many of the details, including local variables and function member calls are similar in this function member to already described function members, and will not be repeated, in the interest of brevity. As discussed above, the SMC maintains an array of instances of the class “NodeState” to describe the states of the various computer systems which it is monitoring. The function member “listenAndRespond” is essentially a main event-handling loop that runs constantly within the SMC to field messages and respond to those messages. This loop is a while-loop comprising lines 14-120. In this while-loop, a next message is received via a call to the function member “receive” of the data member “com” on line 16. When the message is received, the communications-medium address of the process or computer system that sent the message is stored in the local variable “nd” on line 18. Then, a large switch statement is executed, on line 19, to direct execution to the handler for the particular type of message received. Each handler follows a case statement for the message type, with handlers beginning on lines 22, 47, 57, and 83. In general, one or more response messages are generated by the handler and inserted into the local instance of the class “returnMessages” “rM.” After the received message is handled by one of the handlers introduced by a case statement, any returned messages are sent out through the secure communications interface represented by data member “com” in the while-loop of lines 101-118. Note that SMC authentication ack and status query messages are sent out encrypted, while SMC authentication failure, SMC ACK, SMC failure, and status inquiry response messages are sent out without encryption. For example, an SMC authentication failure message is sent out when the SMC cannot decrypt an initial authentication message received from a computer system. Therefore, the SMC has no way to encrypt the SMC authentication failure message with which it responds to the received initial authentication message that it could not decrypt.

Handling of a received initial authentication message occurs on lines 22-44. If the message can be decrypted, as detected on line 27, and the metrics within the message are verified as representing a secure state, as determined on line 30, then an SMC authentication ack message is created for sending back to the computer system, on lines 32-33. In addition, the state of the computer system is recorded in an instance of the class “nodeState” corresponding to the computer system on line 34. If the metrics cannot be verified, then an SMC failure message is prepared for returning to the computer system on line 36. If the message cannot be decrypted, then an SMC authentication failure message is prepared for returning to the computer system on lines 38-40. Note that the current key tag and current identifier for the CD containing encryption keys that the computer system needs to use are returned to the computer system and the SMC authentication failure message. If no corresponding instance of the class “nodeState” can be found for the sender of the initial sender of the authentication message, as detected on line 23, then an SMC failure message is prepared for returning to the computer system on line 42. Whichever response message is prepared, that response message is stored in the local instance of class “responseMessages” on line 43. In the described embodiment, the system administrator for the computer system must have obtained the appropriate CD from the system administrator of the SMC. The system administrator of the SMC then interacts with the SMC to create an instance of the class “nodeState” for the computer system. The absence of an instance of the class “nodeState” corresponding to the computer system indicates that the required interaction between the system administrators has not occurred.

Handling of a received going insecure message occurs on lines 47-54. The SMC sends an SMC ack message back to the computer system, and notes that the computer system is now insecure.

Handling of a status query response from a computer system queried previously by the SMC occurs on lines 57-80. If the message can be decrypted and the metrics contained within the message verified, then the computer system is secure. Otherwise, the computer system is noted as being insecure, on line 71. The security status of the computer system is included in a newly created status inquiry response message, on line 77, and stored for eventual forwarding to each process or computer system waiting for a response from a status inquiry message, in a while-loop of lines 75-79.

Handling of a status inquiry message occurs on lines 83-99. The communications address of the computer system for which the security status is sought is used to find the instance of the class “nodeState” representing that computer system on line 84. If no such instance of the class “nodeState” can be found, then a response to the status inquiry can be immediately created for return to the requester, indicating that the computer system is insecure, on line 87. Otherwise, the communications-address identifier of the requester is inserted into a queue of requesters on line 92 and if the requester is the first requester inserted into the queue, as detected by the returned value of the call to function member “insertInquirer” on line 92, then a new status query message is created and queued for sending to the computer system to inquire of the computer system status on lines 95 and 96. Thus, in the described implementation, the SMC needs to constantly reaffirm the security status of the computer system before reporting that status back to requesters of the status. Note that, should the requester depend on a computer system being in a secure state during an operation, then the requester must check the security status of the computer system both before embarking on the operation and following completion of the operation, since the computer system may transition from a secure state to an insecure state during the operation.

Although the present invention has been described in terms of a particular embodiment, it is not intended that the invention be limited to this embodiment. Modifications within the spirit of the invention will be apparent to those skilled in the art. For example, many different approaches to storing pairs of encryption keys for use by the SMC and a computer system that the SMC monitors can be employed, besides CDs. In the described embodiment, human interaction is required during establishment of a secure state on a computer system, following reset or power on. The system administrator must insert the appropriate CD and direct the computer system to interact with the SMC to establish to the SMC that the computer system is secure. As indicated above, more complex, partially or fully automated techniques may also be possible. An almost limitless number of different message protocols can be derived in order to communicate the security state of a computer system to the SMC, and to allow the SMC to monitor the security state of the computer system. In the described embodiment, only two different possible security states are recognized: secure and insecure. In alternate embodiments, various intermediate security states may also be recognized, and can be determined by the SMC from the metrics supplied by the computer system to the SMC. The above C++-like pseudocode is provided for illustrative purposes only. An almost limitless number of different implementations are possible for implementing the method of the present invention. In the above discussion, the details of the communications medium interconnecting the computer system and the SMC are not provided. Many different types of communications medium may be employed, including serial busses, ethernets, and other such communications media.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A monitor that monitors the security state of a remote computer system, the monitor comprising:
a computing device;
a communications medium interconnecting the computing device with the remote computer system;
a pair of data-storage media each containing a sequence of encryption keys, one data-storage medium local to the monitor, and the other data-storage medium local to the remote computer system; and
a program, running on the computing device, that exchanges with the remote computer system, over the communications medium, messages encrypted using one or more encryption keys extracted from the data-storage medium local to the computer system in order to monitor the security state of the computer system.

2. The monitor of claim 1 wherein, following power on or reset of the computer system, while the computer system is in a relatively high-security state, the computer system sends an initial-authentication message to the monitor, encrypted with a next key extracted from the data-storage medium local to the computer system.

3. The monitor of claim 2 wherein the monitor receives the initial-authentication message, decrypts the initial-authentication message using a next key extracted from the data-storage medium local to the monitor, and stores an indication that the computer system is in a relatively high-security state.

4. The monitor of claim 2 wherein the computer collects security metrics and includes the security metrics in the initial-authentication message.

5. The monitor of claim 4 wherein the monitor receives the initial-authentication message and extracts the security metrics in order to determine the security state of the computer system.

6. The monitor of claim 1 wherein, while the computer system is in a relatively high-security state, prior to loading and/or executing an untrusted software program into memory, the computer system sends a going-insecure message to the monitor, encrypted with a current key extracted from the data-storage medium local to the computer system.

7. The monitor of claim 1 wherein the monitor receives the going-insecure message, decrypts the initial-authentication message using a current key extracted from the data-storage medium local to the monitor, and stores an indication that the computer system is in a relatively low-security state.

8. The monitor of claim 1 wherein the data-storage media both contain identical sequences of encryption keys, and each of the data-storage media are one of:
a compact disc;
a DVD disc;
an electronic memory; and
a magnetic disk.

9. A method for monitoring and reporting the security state of a remote computer system, the method comprising:
providing a monitor computing device interconnected with the remote computer system by a communications medium;
providing a pair of data-storage media, each containing a sequence of encryption keys, one data-storage medium local to the monitor computing device, and the other data-storage medium local to the remote computer system; and
receiving messages from the remote computer system over the communications medium by the monitor and storing an indication, by the monitor, of the security state of the computer system determined by the monitor from the received messages.

10. The method of claim 9 further including receiving, by the monitor, a request for information about the security state of the computer system, and replying with a security-status-inquiry-response message by the monitor based on a determined security state of the computer system.

11. The method of claim 9 further including, following power on or reset of the computer system, while the computer system is in a relatively high-security state, sending, by the computer system, an initial-authentication message to the monitor, encrypted with a next key extracted from the data-storage medium local to the computer system.

12. The method of claim 11 further including receiving, by the monitor, the initial-authentication message, decrypting the initial-authentication message using a next key extracted from the data-storage medium local to the monitor, and storing an indication that the computer system is in a relatively high-security state.

13. The method of claim 11 further including collecting, by the computer system, security metrics and including the security metrics in the initial-authentication message.

14. The method of claim 13 further including receiving, by the monitor, the initial-authentication message and extracting the security metrics in order to determine the security state of the computer system.

15. The method of claim 9 further including sending, by the computer system, a going-insecure message to the monitor, encrypted with a current key extracted from the data-storage medium local to the computer system, while the computer system is in a relatively high-security state, prior to loading and/or executing an untrusted software program into memory.

16. The method of claim 15 further including receiving, by the monitor, the going-insecure message, decrypting the going-insecure message using a current key extracted from the data-storage medium local to the monitor, and storing an indication that the computer system is in a relatively low-security state.

17. Computer instructions implementing the method of claim 9 encoded in a computer-readable medium.

18. A monitor that monitors the security state of a computer system by the method of claim 9.
